(19) United States
(12) Patent Application Publication
(10) Pub. No.: US 2006/0261669 A1
(43) Pub. Date: Nov. 23, 2006

(54) Device for mounting a rotating structure on an axle

(76) Inventor: Jean-Luc Dreyer, Barr (FR)

Correspondence Address: YOUNG & THOMPSON, 745 SOUTH 23RD STREET, 2ND FLOOR, ARLINGTON, VA, 22202, US

(21) Appl. No.: 10/546,065

(22) PCT Filed: Feb. 25, 2004
(86) PCT No.: PCT/FR04/00425

§ 371 Date: May 24, 2006

(30) Foreign Application Priority Data
Feb. 28, 2003 (FR) 03/02492

(51) Int. Cl. B60B 37/00

(52) U.S. Cl. 301/111.01; 301/121

(57) ABSTRACT

The invention relates to a device which is used to mount a rotating structure comprising a hub on an axle, said axle being mounted in the aforementioned hub by means of an axial socket joint. The invention also relates to an object or device comprising at least one wheel structure which is mounted on an axle using said device. The device is characterised in that either the axle (2) or the hub (3) is provided with at least one means (4) for supporting the axle (2) in the hub (3) or the hub (3) on the axle (2). The aforementioned support means (4) is made from a recyclable synthetic material and comprises at least one elastically-deformable tab or fin (4′) which is automatically engaged in at least one recess (5) in the hub (3) or the axle (2) when the latter elements are disposed in a determined axial position in relation to one another.

The present invention relates to the field of mounting rotatable structures, particularly hollow members of synthetic material, in particular wheels, steering wheels and all other hollow members forming a circular ring or not, on an axle, and has for its object a mounting device for a rotatable structure on an axle.

The invention also relates to an object or wheeled machine comprising at least one wheel structure mounted on an axle by use of this mounting device.

Such wheel structures can be for example made according to the process of production as described in French patent application No. 02 05467 filed Apr. 30, 2002 by the applicant, as well as in French patent No. 98 16290 filed Dec. 21, 1998, by the applicant (Publication No. 2 787 382). These processes permit in particular producing wheeled structures of a recyclable material such as for example high density polyethylene.

For mounting such wheeled structures on an axle, the latter at present have a metallic lug snapped into an opening of the hub and adapted to snap into a throat or groove of the axle provided for this purpose.

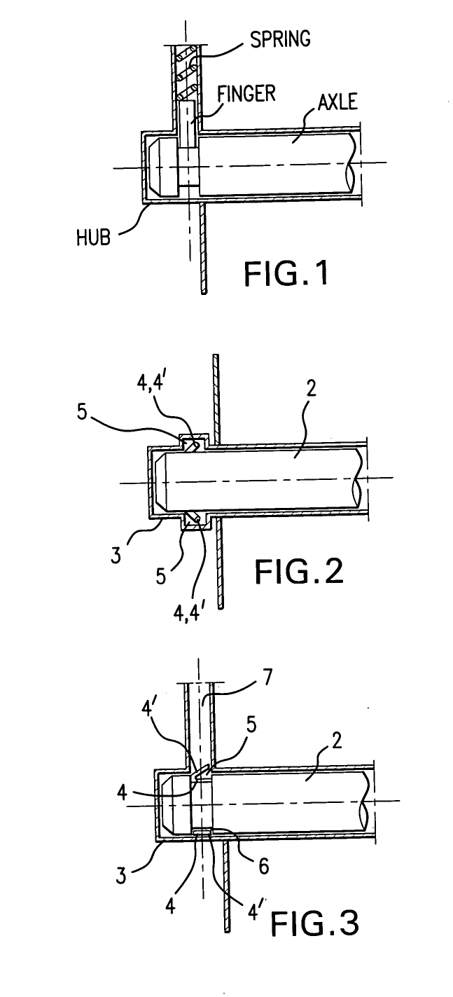

Another securement means of wheeled structures on an axle consists in using a retractable finger actuated by a spring which engages in a groove on the axle provided for this purpose. This finger is guided in translation in an opening of the hub of the wheel (see FIG. 1).

The drawback of these two types of mounting of the wheeled structure on an axle, resides in the fact that they required the use of metallic pieces such as the finger, the lug and the spring. It follows that the wheel structure with its mounting and retaining means on the axle is not totally recyclable and thus requires disassembly and sorting the metallic pieces before the operation of recycling. This gives rise to an increase in the cost associated with recycling, as well as a loss of time due to the supplemental step of disassembly and sorting.

The present invention has particularly for its object overcoming these drawbacks and providing a mounting device for a wheel structure on an axle, having a simple construction and low production cost, comprising no metallic member and if desired adaptable to structures of existing wheels and/or axles.

To this end, the invention has for its object a device for mounting a rotatable structure on an axle, said rotatable structure, preferably in the form of a wheel, comprising a hub in the form of a hollow sleeve with a circular cross-section and said axle being mounted in an axial socket in said hub, characterized in that the axle or the hub is provided with at least one retaining means for the axle in the hub or of the hub on the axle, made of a recyclable synthetic material, comprising at least one resiliently deformable tongue or fin that automatically comes into engagement in at least one recess in the hub or axle, when these latter are located in a predetermined axial position relative to each other.

The invention will be better understood from the following description, which relates to a preferred embodiment, given by way of non-limiting example, and explained with reference to the accompanying schematic drawings, in which:

FIG. 1 is a transverse cross-sectional view showing an existing wheel structure mounted on an axle;

FIG. 2 is a transverse cross-sectional view showing a mounting device of a wheel structure on an axle according to a first embodiment of the invention;

FIG. 3 is a transverse cross-sectional view showing a mounting device of a wheel structure on an axle according to a first variation of a second embodiment of the invention;

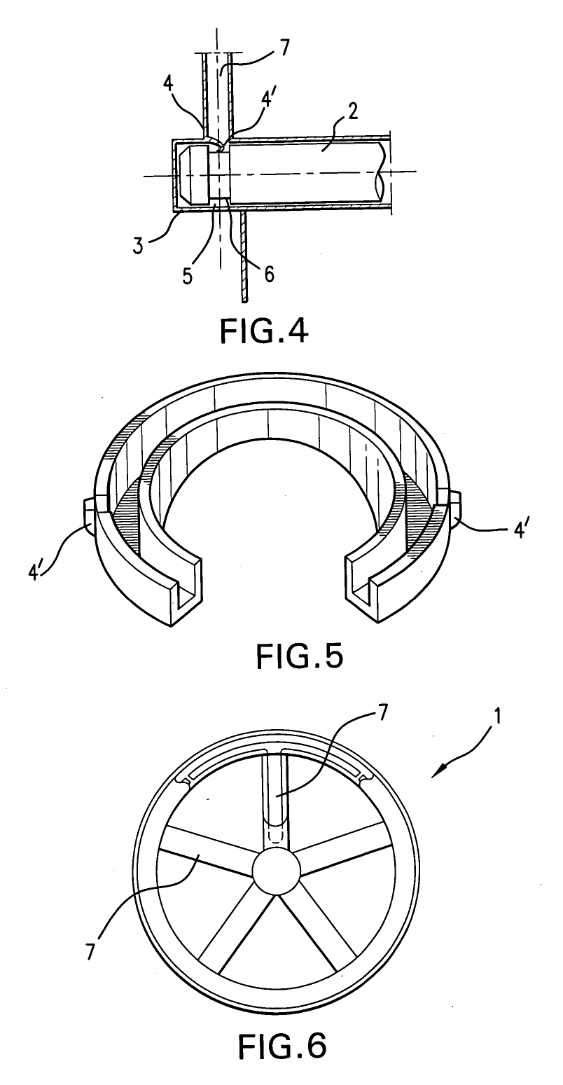

FIG. 4 is a transverse cross-sectional view showing a mounting device for a wheel structure on an axle according to a second arrangement of a second embodiment of the invention;

FIG. 5 is a perspective view of a retaining means for the axle in the hub according to the invention, and FIG. 6 is a side elevational view partially in cross-section, of a wheel of hollow annular cross-section that can be mounted on an axle by means of the mounting device of the invention.

FIGS. 2 to 4 of the accompanying drawings show by way of example a mounting device for a rotatable structure 1 on an axle 2, said rotatable structure, preferably in the form of a wheel, comprising a hub 3 in the form of a hollow sleeve of circular cross-section and said axle 2 being mounted in an axial socket in said hub 3.

According to the invention, the axle 2 or the hub 3 is provided with at least one means 4 for retaining the axle 2 in the hub 3 or of the hub 3 on the axle 2, made of a recyclable synthetic material, comprising at least one elastically deformable tongue or fin 4′ that automatically comes into engagement in at least one recess 5 of the hub 3 or the axle 2, when these latter are located in a predetermined axial position relative to each other.

Said predetermined axial position of the hub 3 relative to the axle 2 corresponds to an abutment position in which the retaining means 4 snap into the corresponding recess or recesses 5 of the hub 3 or the axle 2, thereby ensuring the holding of the axle 2 in the hub 3 by an axial securement resulting from automatic engagement of the tongue or tongues or fin or fins 4′ in the recess or recesses 5.

The mounting device of the invention permits for example mounting on an axle 2 a wheel of hollow cross-section, such as is shown in FIG. 6.

According to one characteristic of the invention, said at least one tongue or fin 4′ can be located either, in the absence of being stressed, in a deployed position in which it extends radially so as to extend outwardly from the external surface of the axle 2, or from the internal surface of the hub 3, or, when stressed, in a bent position against the external surface of the axle 2 or against the internal surface of the hub 3, by bearing against the internal surface of the hub 3 or against the external surface of the axle 2, the assembly operation comprising at least one phase in which said at least one tongue or fin 4′ is bent under stress, followed by a phase in which said at least one tongue or fin 4′ is deployed without stress, said second phase corresponding to the elastic engagement of said at least one tongue or fin 4′ in said at least one recess 5 and the passage from the first to the second phase taking place by relative axial displacement between the hub 3 and the axle 2.

FIG. 3 shows the two possible conditions which each tongue or fin 4′ can have. In this figure, a first tongue or fin 4′, located in the corresponding recess 5 of the hub 3, is extended because it is not subject to any stress, whilst the other tongue or fin 4′ is in a bent condition, under stress and bearing against the internal surface of the hub 3.

In a first modified embodiment of the invention, the mounting device can comprise at least one recess 5, which can be local or extend circumferentially about the internal surface of the hub 3 or the external surface of the axle 2, the retaining means 4 comprising one or several resilient tongues or fins 4′, as the case may be, distributed circumferentially and each adapted to come into engagement, as the case may be, in a corresponding recess 5, when the hub 3 and the axle 2 are located in a predetermined axial position relative to each other.

According to a second modified embodiment of the invention, the mounting device can comprise at least two, preferably several, recesses 5, distributed circumferentially about the internal surface of the hub 3 or the external surface of the axle 2, the retaining means 4 comprising a single resilient tongue or fin 4′ or several tongues or fins 4′ distributed circumferentially, each adapted to come into engagement, as the case may be, in a corresponding recess 5 when the hub 3 and the axle 2 are located in a predetermined axial position relative to each other.

According to the number of recesses 5 and the tongues or fins 4′, the relative axial movement between the hub 3 and the axle 2 during the second phase of assembly described above, is different. Thus, in the case in which the mounting device has a single recess 5 extending circumferentially about the internal surface of the hub 3 or the external surface of the axle 2, a translation of the axle 2 in the hub 3 suffices to engage each tongue or fin 4′ in said single recess 5. The mounting is thus carried out for the mounting device shown in FIG. 4, in which the assembly is thus carried out for the mounting device shown in FIG. 4, in which the axle 2 comprises a single recess 5 in the form of a groove extending circumferentially about the external surface of the axle 2, in which the end of the retaining means 4 engages, as also in the case of the mounting device shown in FIG. 2, in which the retaining means 4 engages in the single recess 5 extending circumferentially about the internal surface of the hub 3. FIG. 2 shows a mounting device comprising a single recess 5 extending circumferentially about the internal surface of the hub 3 and in which the mounting of the axle 2 in the hub 3 takes place by translation of the axle 2 in the hub 3 until the retaining means 4 snaps into the single recess.

When the mounting device comprises a single localized recess 5 (see FIG. 3), it can be advantageous to have several tongues or fins 4′. Thus, the tongues or fins 4′ for which there are no corresponding recesses 5 into which they could extend, will be bent back, under stress, against the external surface of the axle 2 or against the internal surface of the hub 3 and thus ensure, by this compression, a better holding of the tongue or fin 4′ in the corresponding recess 5.

In the case in which the mounting device comprises a localized recess or several recesses 5 distributed circumferentially, the relative axial movement between the hub 3 and the axle 2 during the second phase of assembly consists in translation of the axle 2 in the hub 3, followed by rotation of the axle 2 relative to the hub 3, so as to bring the recess or recesses 5 into registry with the tongue or tongues or fin or fins.

According to a first embodiment of the invention, the retaining means 4 can preferably be a separate element connected to the axle 2 before introduction into the hub 3. As shown in the accompanying FIG. 5, the retaining means 4 can preferably be present in the form of a resiliently deformable member made in the form of a portion of a C shaped ring having a transverse cross-section of U shape and comprising at its external leg at least one recess or protruding portion forming the tongue or tongues or fin or fins 4′, said retaining means 4 being mounted in a groove 6 in the axle 2. So as to ensure good retention of the axle 2 in the hub 3, the resiliently deformable member can preferably have two portions that protrude or are recessed. The resilient characteristics of each member will be selected to permit its mounting on the axle 2 such that it recovers its initial form after said assembly. The material for producing the connected member could be a material identical to that of the wheel and/or the axle 2, for example high density polyethylene, polypropylene or the like. This member ensures the adaptation of the mounting device to any axle having a groove 6.

According to a second embodiment of the invention, the retaining means 4 can preferably be in the form of a single piece by molding with the hub 3 over the axle 2. The structure of the wheel 1 can preferably have at least one hollow radius 7 formed in a single piece with the hub 3 and opening on this latter at a portion of the closure wall forming a retaining means 4 terminating in a free portion forming a tongue or fin 4′, adapted to come into engagement in a corresponding recess 5 of the axle 2 when the hub 3 and the axle 2 are located in a predetermined axial position relative to each other. This embodiment, shown in FIG. 4, permits avoiding assembly of a connected piece on groove 6 of the axle 2.

The hollow radial 7 can for example be made by molding with the help of a hub or by any other technique described in the documents mentioned above. The free portion forming a tongue or fin 4′ can be made by use of two half hubs during molding of the structure of the wheel 1, for example. A portion of the closure wall is preferably in the form of a hooked structure which ensures the holding or blocking of the axle 2 in the hub 3 or of the means on the axle, and this in the two axial directions (see FIG. 4). Thus, after snapping in of the tongue or fin 4′ into the groove 6 of the axle 2, this latter and the hub are axially secured together with a certain play, whilst permitting free rotation of the hub 3 about the axle, as in the other modified embodiment shown in FIGS. 2 and 3. Moreover, it is possible to provide the securement of an element such as a cover (not shown) on the free end of the hub 3 to avoid dirt and dust penetrating the hub 3.

FIG. 2 shows an assembly device in which the retaining means 4 is formed in a single piece with the axle 2. In this embodiment, the axle 2 can be covered with a recyclable material such as for example high density polyethylene or polypropylene, or can be made entirely of this material, to facilitate recycling of the assembly device.

As shown in FIGS. 2 and 3, in which the retaining means 4 is a piece formed in a single piece with the axle 2 or is a piece connected to the axle, the structure of wheel 1 can preferably have at least one hollow radial 7 formed in a single piece with the hub 3 and opening on this latter, the opening forming a reinforcement 5 (see FIG. 3). The cross-section of the opening can be circular or not. The production of the hollow radial 7 in a single piece with the hub 3 can be carried out for example according to the production process described in the documents cited above.

The invention also relates to an object or machine comprising at least one velocipede wheel structure 1, characterized in that each wheel structure 1 is mounted on an axle by means of the assembly device according to the invention. These wheel structures 1 can for example be made according to the process of production in the documents cited above. These wheel structures can be mounted for example on tricycles for children, containers, mowers, or other objects or machines adapted to move by means of one or several hollow structures 1.

Thanks to the invention, it is possible to produce a wheel structure with its assembly and holding means on the axle, which is entirely recyclable and which requires no sorting operation before recycling.

Of course, the invention is not limited to the embodiment described and shown in the accompanying drawings. Modifications remain possible, particularly as to the construction of the various elements or by substitution of technical equivalents, without thereby departing from the scope of protection of the invention.

1. Device for assembling a rotatable structure on an axle, said rotatable structure, preferably in the form of a wheel, comprising a hub in the form of a hollow sleeve of circular cross-section and said axle being mounted in an axial socket in said hub, characterized in that the axle (2) or the hub (3) is provided with at least one retaining means (4) for the axle (2) in the hub (3) or the hub (3) on the axle (2), made of a recyclable synthetic material, comprising at least one resiliently deformable tongue or fin (4′) that automatically comes into engagement in at least one recess (5) of the hub (3) or of the axle (2), when these are located in a predetermined axial position relative to each other.

2. Assembly device according to claim 1, characterized in that said at least one tongue or fin (4′) is located either, in the absence of stress, in a deployed position in which it extends radially protuberantly from the external surface of the axle (2), or of the internal surface of the hub (3), or, under stress, in a bent condition against the external surface of the axle (2) or against the internal surface of the hub (3), by bearing against the internal surface of the hub (3) or against the external surface of the axle (2), the assembly operation comprising at least one phase in which said at least one tongue or fin (4′) is bent under stress, followed by a phase in which said at least one tongue or fin (4′) is extended without stress, said second phase corresponding to the resilient engagement of said at least one tongue or fin (4′) in said at least one recess (5) and the passage from the first to the second phase taking place by relative axial movement between the hub (3) and the axle (2).

3. Assembly device according to claim 2, characterized in that it comprises at least one recess (5), which is localized or extends circumferentially about the internal surface of the hub (3) or of the external surface of the axle (2), the holding means (4) comprising one or several tongue or tongues or fin or fins (4′) that are resilient, as the case may be distributed circumferentially and adapted to come into engagement each, as the case may be, in a corresponding recess (5), when the hub (3) and the axle (2) are located in a predetermined axial position relative to each other.

4. Assembly device according to claim 2, characterized in that it comprises at least two, preferably several, recesses (5), distributed circumferentially about the internal surface of the hub (3) or the external surface of the axle (2), the holding means (4) comprising a single resilient tongue or fin (4′) or several tongues or fins (4′) distributed circumferentially, adapted to come into engagement each in a corresponding recess (5) when the hub (3) and the axle (2) are located in a predetermined axial position relative to each other.

5. Assembly device for a wheel structure on an axle, according to 4 claim 1, characterized in that the holding means (4) is a separate element secured to the axle (2) before engagement in the hub (3).

6. Assembly device according to claim 1, characterized in that the holding means (4) is formed of a single piece by molding with the hub (3) or the axle (2).

7. Assembly device according to claim 5, characterized in that the holding means (4) is in the form of a resiliently deformable member in the form of a portion of a C-shaped ring having a transverse U-shaped cross-section and comprising on its outer leg at least one protruding or sunk portion forming the tongue or tongues or fin or fins (4′), said holding means (4) being assembled in a groove (6) on the axle (2).

8. Assembly device according to claim 1, characterized in that the wheel structure (1) has at least one hollow radial (7) formed in a single piece with the hub (3) and opening onto this latter, the opening forming a recess (5).

9. Assembly device according to claim 1, characterized in that the wheel structure 1 has at least one hollow radial (7) formed of a single piece with the hub (3) and opening onto this latter at a wall portion that provides a closure forming a holding means (4) terminating in a free portion forming a tongue or fin (4′), adapted to come into engagement in a corresponding recess (5) of the axle (2) when the hub (3) and the axle (2) are located in a predetermined axial position relative to each other.

10. Object or machine comprising at least one wheel structure, characterized in that each wheel structure (1) is mounted on an axle (2) by means of an assembly device according to claim 1.
